(19) United States
(12) Patent Application Publication
(10) Pub. No.: US 2017/0024226 A1
(43) Pub. Date: Jan. 26, 2017

(54) INFORMATION PROCESSING METHOD AND ELECTRONIC DEVICE

(71) Applicants: Beijing Lenovo Software Ltd., Beijing (CN); Lenovo (Beijing) Limited, Beijing (CN)

(72) Inventor: Shi Yan, Beijing (CN)

(21) Appl. No.: 14/940,653

(22) Filed: Nov. 13, 2015

(30) Foreign Application Priority Data
Jul. 24, 2015 (CN) 201510441329.6

(51) Int. Cl. G06F 9/44; G06F 3/0484; G06F 9/52; G06F 3/0482

(52) U.S. Cl. CPC G06F 9/4443; G06F 3/0482; G06F 3/04842; G06F 3/04845; G06F 9/52

(57) ABSTRACT

The present disclosure provides an information processing method and an electronic device. The information processing method comprises: acquiring an input operation to generate an instruction for invoking a task manager; responding to the instruction for the task manager to invoke M application programs which are already in an operational state, wherein M is an integer greater than or equal to 1; and controlling an application interface of each of the M application programs to be displayed in a window manner, wherein when the application interface of said each application program is displayed in the window manner, said each application program is in an activated state. The present disclosure provides the above method to solve the technical problem in the related art that an operation cannot be performed on a displayed object in a displayed application program in a task manager.

### CROSS-REFERENCE TO RELATED APPLICATION(S)

This application claims priority to the Chinese Patent Application No. 201510441329.6, filed on Jul. 24, 2015, entitled “INFORMATION PROCESSING METHOD AND ELECTRONIC DEVICE” which is incorporated herein by reference in its entirety.

### TECHNICAL FIELD

The present disclosure relates to the field of electronic technology, and in particular, to an information processing method and an electronic device.

### BACKGROUND

With rapid development of communication technology, electronic devices such as smart phones, tablet computers or the like become a part of people's lives, and have increasing popularity. The electronic devices can provide different services and functions to satisfy users' requirements, and people's lives are also changed by a variety of application software which emerges in endlessly.

When a user uses different application programs, the user needs to implement various operations on different information displayed in the various application programs, for example, copying or pasting a picture, inputting or deleting a character, playing or transmitting voice or the like.

In the process of implementing the technical solutions according to the embodiments of the present disclosure, the inventor of the present disclosure discovers the following technical problem in the related art that when a user implements an operation in a task manager of an electronic device, the user can only implement operations such as deleting a thumbnail of a running interface as a whole, entering an application, and displaying application information. If there is a need to operate on an object in the thumbnail of the running interface, it needs to firstly click on the thumbnail of the running interface in the task manager to activate an application program, and then operate on a displayed object on an interface of the activated application program. When the application program is to be switched, it needs to return to the task manager again to implement the same operation. In the related art, thumbnails representing application programs which currently run in the foreground and in the background are displayed in a multi-task manager. The thumbnails are substantially the same as icons on the desktop or in a menu of application programs, and an effect of selecting a thumbnail is the same as that of selecting an icon. When application programs are used in a task manager, the operation process is complex and the efficiency is low, which influences user experience.

### SUMMARY

The present disclosure provides an information processing method and an electronic device, to solve the technical problem in the related art that an operation cannot be implemented on a displayed object in a displayed application program in a task manager.

In order to solve the above technical problem, in an aspect of a first embodiment of the present disclosure, an information processing method is provided, comprising:

acquiring an input operation to generate an instruction for invoking a task manager;

responding to the instruction for the task manager to invoke M application programs which are already in an operational state, wherein M is an integer greater than or equal to 1;

controlling an application interface of each of the M application programs to be displayed in a window manner, wherein when the application interface of said each application program is displayed in the window manner, said each application program is in an activated state,

wherein when the M application programs are in an activated state, the M application programs can respond to interactive operations implemented by a user on displayed objects on the application interfaces of the M application programs.

Alternatively, before acquiring an input operation, only one of the M application programs can run in the foreground at the same time, and remaining application programs run in the background.

Alternatively, responding to the instruction for the task manager comprises:

enabling a multi-task management mode, wherein when the electronic device is in the multi-task management mode, the electronic device supports a first type of interactive operations implemented on displayed objects in the windows in the multi-task management mode.

Alternatively, after controlling an application interface of each of the M application programs to be displayed in a window manner, the method further comprises:

acquiring a first input operation via a sensor of the electronic device; and

determining whether the first input operation belongs to the first type of interactive operations.

Alternatively, after determining whether the first input operation belongs to the first type of interactive operations, the method further comprises:

when the first input operation belongs to the first type of interactive operations, determining a first operation instruction according to first input information of the first input operation;

submitting the first operation instruction to a first application program corresponding to a first window which is determined based on the first input information; and

responding, by the first application program, to the first operation instruction based on a displayed object in the first window.

Alternatively, after determining whether the first input operation belongs to the first type of interactive operations, the method further comprises:

when the first input operation belongs to the first type of interactive operations, submitting second input information of the first input operation to a first application program corresponding to a first window which is determined based on the second input information;

generating, by the first application program, a second operation instruction according to the second input information; and

responding, by the first application program, to the second operation instruction based on a displayed object in the first window.

In another aspect of the embodiment of the present disclosure, an electronic device is provided, comprising:

a housing;

an input apparatus arranged in the housing and configured to acquire an input operation;

a display arranged on the housing; and

a processor arranged in the housing and configured to generate an instruction for invoking a task manager based on the input operation; make a response to the instruction for the task manager to invoke M application programs which are already in an operational state, wherein M is an integer greater than or equal to 1; control an application interface of each of the M application programs to be displayed in a window manner on the display, wherein when the application interface of said each application program is displayed in the window manner, said each application program is in an activated state, wherein when the M application programs are in an activated state, the M application programs can respond to interactive operations implemented by a user on displayed objects on the application interfaces of the M application programs.

Alternatively, before the input apparatus acquires an input operation, only one of the M application programs can run in the foreground at the same time, and remaining application programs run in the background.

Alternatively, the processor is configured to enable a multi-task management mode, wherein when the electronic device is in the multi-task management mode, the electronic device supports a first type of interactive operations implemented on displayed objects in the windows in the multi-task management mode.

Alternatively, the electronic device further comprises a sensor, wherein,

the processor is configured to acquire a first input operation via the sensor after controlling an application interface of each of the M application programs to be displayed in a window manner on the display; and

the processor is further configured to determine whether the first input operation belongs to the first type of interactive operations.

Alternatively, the processor is further configured to:

when the first input operation belongs to the first type of interactive operations, determine a first operation instruction according to first input information of the first input operation; submit the first operation instruction to a first application program corresponding to a first window which is determined based on the first input information; and control the first application program to make a response to the first operation instruction based on a displayed object in the first window.

Alternatively, the processor is configured to:

when the first input operation belongs to the first type of interactive operations, submit second input information of the first input operation to a first application program corresponding to a first window which is determined based on the second input information; control the first application program to generate a second operation instruction according to the second input information; and control the first application program to make a response to the second operation instruction based on a displayed object in the first window.

With one or more of the above embodiments of the present disclosure, at least the following technical effects can be achieved:

When an input operation is acquired, an instruction for invoking a task manager is generated. A response is made to the instruction for the task manager to invoke M application programs which are already in an operational state. An application interface of each of the M application programs is controlled to be displayed in a window manner, and each application program is in an activated state. In this way, the M application programs displayed in the task manager can respond to interactive operations implemented between a user and application programs. In the technical solutions of the present disclosure, functions of the task manager are extended. Application programs displayed in the task manager are in an activated state, and a user can implement interactive operations on the application programs in the task manager. When interactive operations are implemented by the user on the application programs, the operation process is simplified, and the operation efficiency is improved, thereby achieving simple and convenient operations implemented on multiple application programs.

### BRIEF DESCRIPTION OF THE DRAWINGS

FIG. 1 is a flowchart of an information processing method according to a first embodiment of the present disclosure;

FIG. 2 is a diagram of a first implementation of step 103 in the method illustrated in FIG. 1;

FIG. 3 is a diagram of a second implementation of step 103 in the method illustrated in FIG. 1;

FIGS. 4A-4F are diagrams of interactive operations implemented on windows of application programs according to the first embodiment of the present disclosure; and

FIG. 5 is a structural diagram of an electronic device according to a second embodiment of the present disclosure.

### DETAILED DESCRIPTION

The present disclosure provides an information processing method and an electronic device, to solve the technical problem in the related art that an operation cannot be implemented on a displayed object in a displayed application program in a task manager.

In order to solve the above technical problem, a general idea of the technical solutions according to the embodiments of the present disclosure is as follows.

When an input operation is acquired, an instruction for invoking a task manager is generated. A response is made to the instruction for the task manager to invoke M application programs which are already in an operational state. An application interface of each of the M application programs is controlled to be displayed in a window manner, and each application program is in an activated state. In this way, the M application programs displayed in the task manager can respond to interactive operations implemented between a user and application programs.

In the related art, on the one hand, when operations are to be implemented on different application programs, it needs to switch between application interfaces of the application programs, which results in a complex operation process and low efficiency. On the other hand, thumbnails of application programs which are currently running are displayed in a task manager, and only operations such as deleting an application program as a whole, entering an application and displaying application information can be implemented. In the technical solutions of the present disclosure, functions of the task manager are extended. Compared with the thumbnails having the same functions as those of the icons in the related art, application programs in a multi-task management mode are displayed in a window manner, and are in an activated state. As a result, a user can implement interactive operations on the application programs in the task manager. Thereby, the present disclosure achieves technical effects of stronger functions of the task manager and simple and convenient operations implemented on multiple application programs.

In order to better understand the above technical solutions, the technical solutions of the present disclosure will be described in detail below in conjunction with accompanying drawings and specific embodiments. It should be understood that the embodiments of the present disclosure and the specific features in the embodiments are used to explain the technical solutions of the present disclosure in detail, instead of limiting the technical solutions of the present disclosure. Without a conflict, the embodiments of the present disclosure and the technical features in the embodiments can be combined with each other.

### First Embodiment

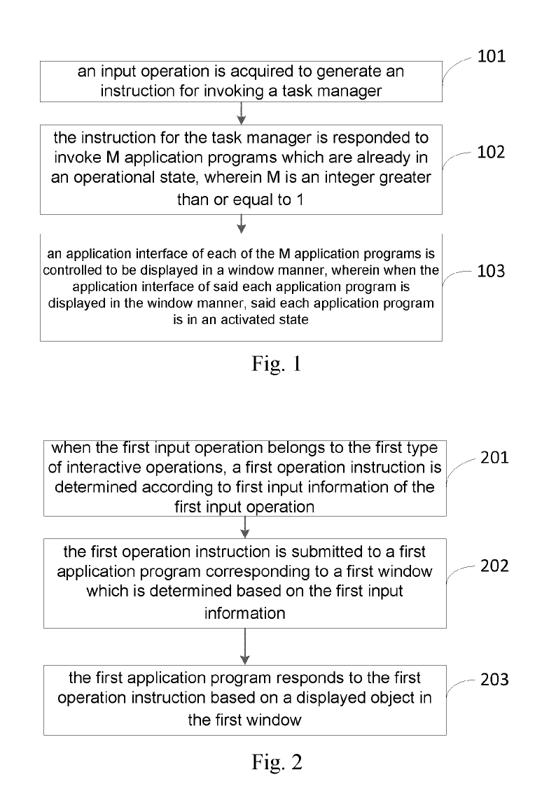

With reference to FIG. 1, the present disclosure provides an information processing method applied in an electronic device. The electronic device may be a smart phone, a tablet computer or the like, and multiple application programs may run at the same time in the foreground or in the background in the electronic device.

As shown in FIG. 1, a main flow of the information processing method will be described as follows.

In step 101, an input operation is acquired to generate an instruction for invoking a task manager;

in step 102, a response is made to the instruction for the task manager to invoke M application programs which are already in an operational state, wherein M is an integer greater than or equal to 1;

in step 103, an application interface of each of the M application programs is controlled to be displayed in a window manner, wherein when the application interface of said each application program is displayed in the window manner, said each application program is in an activated state,

wherein when the M application programs are in an activated state, the M application programs can respond to interactive operations implemented by a user on displayed objects on the application interfaces of the M application programs.

Specifically, in step 101 of acquiring an input operation to generate an instruction for invoking a task manager, the input operation is generally an operation of implementing long press on a home key of the electronic device, and the electronic device acquires the input operation when a user implements long press on the home key, and generates the instruction for invoking the task manager according to the input operation.

Alternatively, before acquiring an input operation in step 101, at most one application program runs in the foreground of the electronic device at the same time. That is, before acquiring the input operation, among M application programs which run at the same time in the foreground and in the background of the electronic device, only one application program can run in the foreground and remaining M−1 application programs run in the background, or all of the M application programs run in the background.

When the application program runs in the foreground, a window of the application program is displayed, and an interactive operation may be implemented by a user on a displayed object in the window. When the application program runs in the background, the application program is in a state that the window thereof is minimized and hidden. When the application program runs in the background, the application program is not closed, and still runs in the task manager and occupies system resources. When a user needs to use the application program, the application program can be rapidly invoked. For example, in a case that Music Box is firstly started in the electronic device, Short Message Service is started without exiting Music Box and a short message is edited in an operation Short Message Service window, Short Message Service runs in the foreground, and Music Box runs in the background and can be rapidly invoked by a user at any time.

After the instruction for invoking a task manager is generated in step 101, step 102 is then performed, i.e., responding to the instruction for the task manager to invoke M application programs which are already in an operational state, wherein M is an integer greater than or equal to 1. After the instruction for the task manager is generated in step 101, the electronic device makes a response to the instruction for the task manager, to determine and invoke all of the M application programs which are currently running in the foreground and in the background of the electronic device.

Specifically, the electronic device makes a response to the instruction for the task manager, to enable a multi-task management mode in the task manager. When the electronic device is in the multi-task management mode, the electronic device supports a first type of interactive operations implemented on displayed objects in windows in the multi-task management mode and a second type of interactive operations implemented on the windows. In the embodiment, in the whole operation process of the first type of interactive operations and the second type of interactive operations, all of the operations are implemented on a display interface of the task manager all the time without exiting the task manager.

The first type of interactive operations are interactive operations implemented on displayed objects in windows of application programs, and are general functions provided by the task manager in the multi-task management mode, for example, operations such as deletion, copy, paste, forward, collection or the like implemented on displayed objects such as a text, a picture or the like, and operations such as playing a music, transmitting voice information, submitting a verification code, logging in or the like.

The second type of interactive operations are operations implemented on windows of the application programs, for example, single click to enter an application program, flick to close an application program, drag to move a window of an application program, drag with two fingers to change a size of a window of an application program or the like. Compared with the first type of interactive operations, the second type of interactive operations are operations implemented on the windows of the application programs as a whole.

After M application programs in an operation state are invoked in step 102, step 103 is then performed, i.e., controlling an application interface of each of the M application programs to be displayed in a window manner. When the application interface of each application program is displayed in a window manner, each application program is in an activated state.

After the task manager is invoked by the electronic device, all of the M application programs which are currently running are displayed on the application interface of the task manager. Alternatively, when the application interface of each application program is displayed in a window manner, a state that each application program runs in the foreground or in the background is the same as that before the input operation is acquired.

That is, in the present embodiment, the functions of the task manager are improved. In the multi-task management mode, the M application programs displayed in the task manager are not thumbnails which are merely used to represent application programs in the related art. Instead, application interfaces of all application programs in an operation state are zoomed out and are then uniformly displayed in a window manner on the display interface of the task manager. Further, a state of each application program is the same as that before the input operation is acquired, and content displayed in each window corresponds to an application program which runs in the background, and an operation is supported to be implemented on each window. That is, each application program is in an activated state, and a user may implement an operation on any displayed application program in the task manager.

When the application programs are displayed in a window manner in the task manager, there may be multiple different display manners according to a number of the application programs, types of the application programs, sizes of display windows or the like, or the application programs may be displayed adaptively according to a size of the electronic device. At the same time, there may be different arrangement manners for the windows. In a specific implementation, different display manners may be used for the windows according to practical requirements.

In an example, the application programs may be displayed in a predetermined manner, and display windows of the various application programs may be the same. Alternatively, the application programs may also be displayed according to a number of the application programs, and when there are many application programs, the windows of the application programs are correspondingly zoomed out. There may also be different arrangement orders for the windows. The windows may be arranged according to start time of the application programs, or may be arranged according to last usage time of the application programs, or may be arranged according to frequencies of use of the application programs. An order of the windows may also be adjusted manually by a user according to personal requirements and preferences.

When the M application programs are in an activated state after the application programs are displayed in a window manner in the task manager in step 103, the M application programs may make a response to interactive operations implemented by a user on displayed objects on the application interfaces of the M application programs.

In the task manager, the application programs in the multi-task management mode are in an activated state, and a user may implement a first type of interactive operations on the application programs, for example, copying or pasting a text or the like, or a second type of interactive operations on the windows of the application programs, for example, deletion or scaling or the like. As a result, before the interactive operations are implemented, it is determined firstly which type of interactive operation is implemented in a window.

Specifically, after the application interface of each of the M application programs is controlled to be displayed in a window manner, a first input operation is acquired via a sensor of the electronic device, to determine whether the first input operation belongs to the first type of interactive operations.

There are many types of operations implemented by a user on the electronic device, for example, single click, double click, long press, upward flick, downward flick, leftward flick, rightward flick, drag, multi-finger drag, long press and then drag, cross-the-air operation, rotation, swing or the like. In a specific implementation, those skilled in the art may determine different types of input operations implemented by a user according to practical conditions. For example, various operation manners for the first type of interactive operations are stored in the electronic device, and a type of an operation manner of the first input operation may be determined only by comparing the operation manner of the first input operation with the stored various operation manners for the first type of interactive operations. As another example, it may be determined whether the first input operation belongs to the first type of interactive operations according to an operation position of the first input operation. For example, if an operation is implemented on a displayed object in a window of an application program, the operation belongs to the first type of interactive operations, and if the operation is implemented in a blank region in the window of the application program, the operation belongs to the second type of interactive operations.

After it is determined whether the first input operation belongs to the first type of interactive operations, there may be the following two implementations according to a determination result. However, the present disclosure is not limited to the following two implementations.

First Implementation:

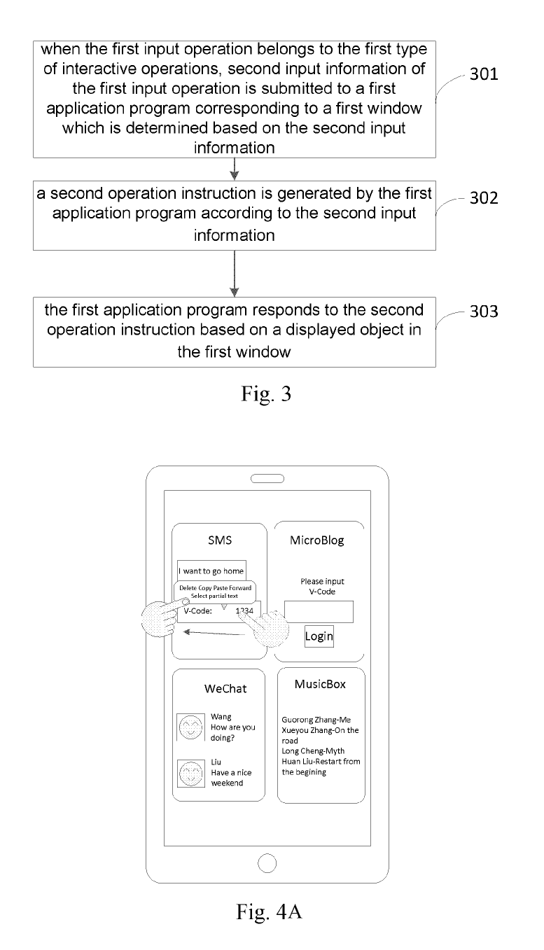

With reference to FIG. 2, a method according to the first implementation comprises the following steps.

In step 201, when the first input operation belongs to the first type of interactive operations, a first operation instruction is determined according to first input information of the first input operation;

in step 202, the first operation instruction is submitted to a first application program corresponding to a first window which is determined based on the first input information; and

in step 203, the first application program makes a response to the first operation instruction based on a displayed object in the first window.

In step 201, when the first input operation belongs to the first type of interactive operations, the first operation instruction is determined according to the first input information of the first input operation. In the present disclosure, when the task manager is in a multi-task management mode, no matter how many windows are displayed when the multi-task manager is started, a particular operation is supported to be implemented by a user on any displayed window, which is a general function provided by the task manager. In the present embodiment, there are two cases in which the first operation instruction is determined according to the first input information of the first input operation.

In a first case, the first operation instruction is directly determined when a user implements the first input operation on the first input information. For example, the first operation instruction is directly determined to be a copy instruction or a paste instruction. In the present embodiment, a type of the first operation instruction is related to the first input information. The first input information may be information of a position where the first input operation is implemented. A type of a displayed object on which the first input operation is implemented may be determined according to the position information, so as to determine the type of the first operation instruction according to the type of the displayed object. Therefore, the first operation instruction comprises a type of the instruction and indication information of a displayed object.

In a second case, when a user implements the first input operation, the first operation instruction is to invoke a list of operation items. That is, a general function provided by the task manager is to display a list of operation items. The list of operation items comprises at least an operation item. The operation item represents a type and an entrance of an operation which can be implemented on an operation object. The operation items comprised in the list of operation items may be one or any combination of copy, deletion, storage, forward, select all and collection supported by the task manager. In a specific implementation, at least one operation item comprised in the list of operation items may be the same for various input operations. The difference is merely in that a type of a displayed object on which the first input operation is implemented may be determined according to the first input information, for example, information of a position where the first input operation is implemented, then operation items which are supported by the type of the displayed object are displayed in a first display manner, and operation items which are not supported by the type of the displayed object are displayed in a second display manner different from the first display manner. Alternatively, the list of operation items may comprise different operation items for various input operations. Specifically, corresponding lists of operation items may be displayed according to different types of displayed objects.

After the first operation instruction is determined in step 201, step 202 is then performed, i.e., submitting the first operation instruction to a first application program corresponding to a first window which is determined based on the first input information. A response needs to be made by an application program to the first operation instruction. As a result, after the first operation instruction corresponding to the first input operation is determined, it needs to determine a first application program which makes a response to the first operation instruction according to the first input information. Specifically, the first input information is for example position information, and a specific window such as a first window in which the first input operation is implemented may be determined according to the position information. Then, a first application program corresponding to the first window is the application program corresponding to the first input operation.

Specifically, step 202 may be different according to two different types of first operation instructions determined in step 201.

In a first case that the first operation instruction is directly determined, the electronic device submits the determined first operation instruction to the first application program corresponding to the first window. In an example, if the first input operation is long press, the first input information is position information, the determined first operation instruction is a copy instruction, and a position where a user implements long press is in a Wechat window, after the application program is determined to be Wechat according to the position information in step 202, the copy instruction and the indication information of the displayed object corresponding to the copy instruction are submitted to Wechat.

In a second case that the determined first operation instruction is to invoke a list of operation items, the user may select to trigger different operation items according to requirements. When an operation item in the list of operation items is triggered, an operation instruction corresponding to the triggered operation item is submitted to the first application program. For example, when an operation item in the list of operation items which is triggered by clicking of a user is deletion, the first input information is position information, and the first window which is determined according to the position information is Wechat window, after the application program is determined to be Wechat in step 202, a deletion instruction and indication information of a displayed object corresponding to the deletion instruction are submitted to Wechat.

After step 202 is performed, step 203 is then performed, i.e., responding, by the first application program, to the first operation instruction based on a displayed object in the first window. In addition to the first application program, a displayed object which makes a response to the first operation instruction may be determined according to the position information of the first input operation. After the first operation instruction is submitted to the first application program, the first application program implements an operation corresponding to the first operation instruction on the displayed object.

In an example, a user implements a first input operation on text information of Wechat, a first operation instruction determined by the first input operation according to the displayed text information is a copy instruction, and the copy instruction is submitted to Wechat. In step 203, after it is determined that an interactive operation implemented by the user is implemented on text information of Wechat according to the position information, the first application program Wechat implements the first operation instruction which is determined in step 201 on the text information, i.e., Wechat copies text information in a window.

Second Implementation:

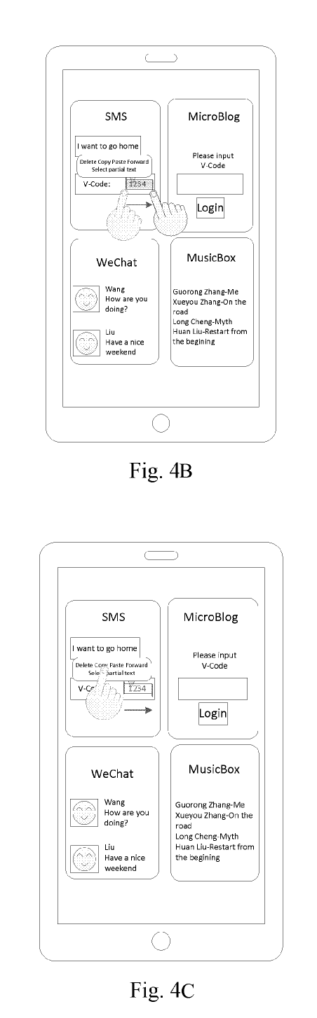

With reference to FIG. 3, a method according to the second implementation comprises the following steps.

In step 301, when the first input operation belongs to the first type of interactive operations, second input information of the first input operation is submitted to a first application program corresponding to a first window which is determined based on the second input information;

in step 302, a second operation instruction is generated by the first application program according to the second input information; and

in step 303, a response is made by the first application program to the second operation instruction based on a displayed object in the first window.

Firstly, step 301 is performed, i.e., when the first input operation belongs to the first type of interactive operations, submitting second input information of the first input operation to a first application program corresponding to a first window which is determined based on the second input information.

In an example, when the first input operation is long press, the second input information is position information, and a position where a user implements long press is in a transmission control in a chat window of Wechat, it is firstly determined that the first application program corresponding to the first window is Wechat, and then the position information of the second input information is submitted to Wechat.

After the second input information is submitted to the first application program in step 301, step 302 is performed. If the task manager submits the transmission control to Wechat in an example of step 301, in step 302, the second operation instruction generated by Wechat according to the transmission control is a transmission instruction.

After the second operation instruction is determined in step 302, step 303 is performed, i.e., responding, by the first application program, to the second operation instruction based on a displayed object in the first window. If Wechat generates a transmission instruction in an example of step 302, in step 303, when it is determined that the displayed object is a transmission control according to the position information, Wechat makes a response to the second operation instruction to implement a transmission operation.

In the implementation, the second operation instruction is generally used to implement operations on a functional control, such as transmission, login, verification or the like. An operation instruction to be executed is to operate on an interactive control in a window, so as to trigger the control to implement the first interactive operation.

In practical applications, in a multi-task management mode, in the whole operation process of a user, the first implementation and the second implementation may be used alternatively. Interactive operations between the user and displayed objects on application interfaces of application programs in the task manager will be described in detail below by way of examples. In the specific implementation, the present disclosure includes but is not limited to the following examples.

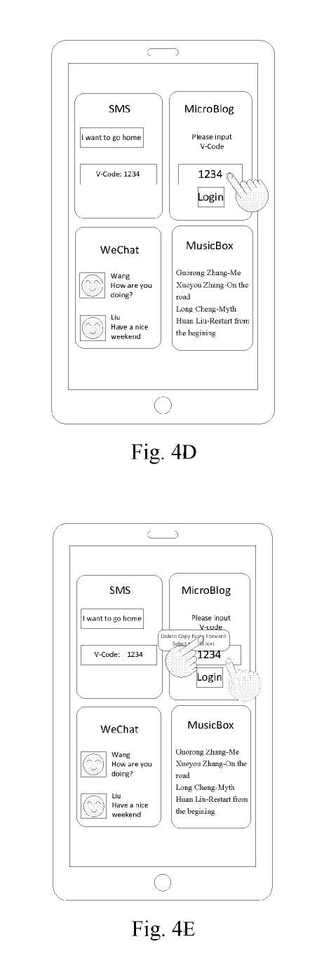

Windows of four application programs are displayed on interfaces of task managers illustrated in FIG. 4a-4f, which are Short Message Service, Microblog, Wechat, and Music Box respectively. In the multi-task management mode, a user may transmit a short message and then directly update Microblog, or may also search for and play music in Music Box, and then directly enter Wechat to chat with friends. For example, when the user logs in Microblog, the user needs to be verified via a verification code. Specifically, the user needs to copy the verification code in Short Message Service, then paste the verification code in Microblog, and finally click on login to enter Microblog. In this process, it needs to use the first implementation and the second implementation in the present embodiment many times, which will be described in detail below.

In FIG. 4a, the user uses Microblog in the multi-task management mode, and a request for a verification code (“V-Code”) to log in Microblog is transmitted to the electronic device according to a prompt from Microblog. After Short Message Service of the electronic device receives the verification code, the verification code is displayed in a Short Message Service window. Firstly, the user implements a first input operation in the Short Message Service window, for example, implements long press on a short message with the verification code, i.e., an operation implemented with a hand in a dotted line in FIG. 4a. The electronic device determines that the first input operation of long press is not an operation implemented on the application program of Short Message Service, and instead, is an operation implemented on a displayed object in the Short Message Service window. That is, the electronic device determines that the operation belongs to a first type of interactive operations.

After it is determined that the long press operation belongs to the first type of interactive operations, interactive operations are implemented according to the first implementation in the embodiment. Firstly, step 201 is performed, i.e., determining a first operation instruction according to first input information of the first input operation. In the example, as a position where the long press is implemented is in the short message, it is determined that the first operation instruction is an instruction of invoking a list of operation items. Then, step 202 is performed, i.e., submitting the first operation instruction to a first application program corresponding to a first window which is determined based on the first input information. In the example, the position where the long press is implemented is in the short message, a window for displaying the short message is a Short Message Service window, and thus an instruction of invoking a list of operation items is submitted to the application program of Short Message Service. Then, step 203 is performed, i.e., responding, by the first application program, to the first operation instruction based on a displayed object in the first window. In the example, the application program of Short Message Service invokes and displays the list of operation items according to the displayed object of short message, wherein the list of operation items comprises multiple operation items. In the example, the operation items enumerated in FIG. 4a are deletion, copy, paste, forward, and selection of a part of text. Since the short message supports such operation items, these operation items are displayed normally in the list of operation items.

As the user needs to acquire the verification code in Short Message Service, after the list of operation items is displayed, the user clicks on “selection of a part of text” in the list of operation items, i.e., an operation implemented with a hand in a solid line in FIG. 4a. Short Message Service makes a response to the click operation to display a movable cursor on characters of the short message. In this process, after it is determined that the click operation of the user belongs to the first type of interactive operations, interactive operations are implemented according to the second implementation in the embodiment. Firstly, step 301 is performed, i.e., submitting second input information of the second input operation to a second application program corresponding to a second window which is determined based on the second input information. In the example, the second input operation is single click, the second input information is “selection of a part of text” in the list of operation items displayed in Short Message Service, and it is determined that the second application program is Short Message Service according to the second input information. In this case, “selection a part of text” in the list of operation items is submitted to Short Message Service. Then, step 302 is performed, i.e., generating, by the second application program, a second operation instruction according to the second input information. In the example, the second operation instruction is invoked according to “selection of a part of text” in the Short Message Service window. Then, step 303 is performed, i.e., responding, by the second application program, to the second operation instruction based on a displayed object in the second window. That is, Short Message Service makes a response to the operation corresponding to the operation item of “selection of a part of text” to display a movable cursor on characters of the short message.

Next, the user selects a verification code to be copied by adjusting a range of the cursor which covers characters, with reference to the operation illustrated in FIG. 4b. In the example, a third input operation implemented by the user also belongs to the first type of interactive operation. In the operation process, interactive operations are implemented according to the second implementation in the embodiment. After a verification code “1234” is selected, the user implements a fourth input operation, i.e., clicking on “copy” in the list of operation items to copy the verification code “1234”, with reference to the operation illustrated in FIG. 4c. This process is the same as the response process when the user clicks on “selection of a part of text”, and will not be described in detail here.

After the user copies the verification code, there is no need to exit the task manager to enter Microblog which is displayed in a full screen, and instead, it only needs to directly implement an operation on displayed objects displayed in the Microblog window in the task manager, i.e., pasting the copied verification code to an input box in the Microblog window. In the example, the user may paste the verification code to the input box in two implementations, which correspond to the methods of step 201 respectively.

The first implementation is shown in FIG. 4d, i.e., after the user implements a fifth input operation, the fifth operation instruction is directly determined to be a paste instruction. The first implementation in the embodiment is used to implement the interactive operation of pasting the verification code to the input box, which is similar to the implementation corresponding to FIG. 4a, and will be described in detail here.

The second implementation is shown in FIG. 4e, i.e., after the user implements the fifth input operation, the list of operation items is invoked, and has operation items similar to those in FIG. 4a. The difference is in that an object on which the fifth input operation is implemented by the user is the input box, and it needs to input characters in the input box. As a result, optional operation items are supported by the input box among the operation items displayed in the list of operation items in FIG. 4e. As the input box does not support operations such as deletion, forward or the like, operation items such as deletion, forward or the like are displayed in gray in the list of operation items, and cannot be triggered, and operation items such as copy, paste, and selection of a part of text are displayed normally. In a specific implementation, those skilled in the art may set the operation items which cannot be triggered according to requirements of applications. In FIG. 4e, the user implements the fifth input operation, thereby the list of operation items is displayed, and then the user further implements a sixth input operation to select an operation item of “paste”. This process is similar to the implementation in FIG. 4a, and will not be described in detail here.

As shown in FIG. 4f, after the user pastes the verification code “1234” to Microblog, the user implements a seventh input operation on a login control of Microblog, and Microblog implements a login operation. The second implementation in the embodiment is used in the process. Specifically, an input operation of clicking on “login” is submitted to Microblog which displays the “login” control, and Microblog generates a login instruction according to the “login” control, and then make a response to the login instruction to transmit the verification code “1234” to a Microblog server for verification and login.

Another possible implementation is that the user implements an input operation to invoke an input method interface, and inputs the verification code manually. In the multi-task management mode, after the user clicks on “transmit a verification code” in Microblog, the user may view a received verification code on a Short Message Service interface in the multi-task manager. As a result, the user only needs to directly input the verification code in the input box of Microblog for verification of login. In the implementation, when the user implements long press on Microblog, an operation instruction determined based on the input operation is an instruction of invoking and displaying an input method interface. After receiving the submitted instruction for displaying an input method interface, Microblog displays the input method interface according to a position of the input box. The user inputs the verification code via the input method, and then triggers the login button. Microblog makes a response to the login instruction to transmit the verification code to the Microblog server for verification and login.

Thus, in the present embodiment, the functions of the task manager are improved. In the multi-task management mode, windows of the displayed application programs are in an activated state, and the application programs are not thumbnails which are merely used to represent application programs in the related art. In the related art, the user must click on a thumbnail of Short Message Service in the multi-task manager to activate the application program of Short Message Service and then implement an operation of copying a verification code; and then the user must return to the multi-task manager to activate Microblog via a thumbnail of Microblog to enter Microblog and implement an operation of pasting the verification code. In the present embodiment, interactive operations are supported to be implemented by the user on various windows, and a switch operation may be implemented by the user between the application programs in the task manager, without exiting the task manager. This simplifies the operation process between the application programs, achieves a simple operation, and improves efficiency in using the electronic device by the user.

In the technical solutions of the present disclosure, functions of the task manager are extended. In addition to operations such as deleting an application program as a whole, entering an application, a user may implements many types of interactive operations on an application program in the multi-task management mode. When operations are implemented on multiple application programs, the user needs not to switch the application programs by exiting the application programs, and may switch any running application program in a window of a task manager which displays the multiple application programs. This can improve the operation efficiency and achieve better user experience.

### Second Embodiment

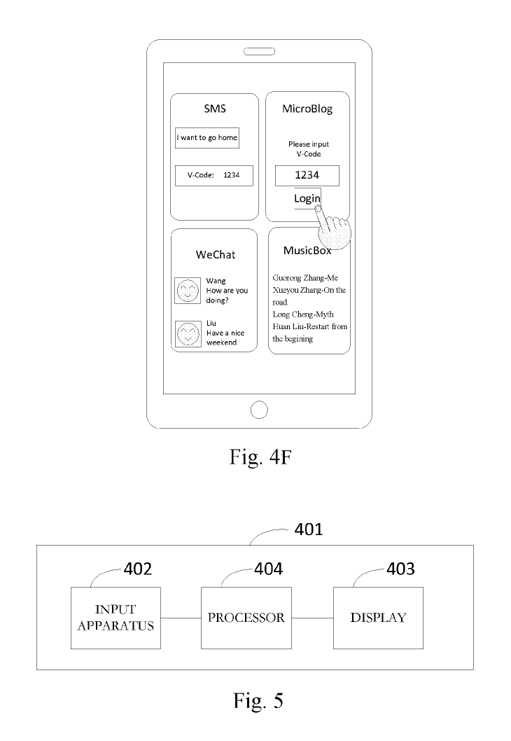

Based on the same inventive concept as that of the information processing method according to first embodiment of the present disclosure, the embodiment of the present disclosure provides an electronic device, as shown in FIG. 5, which comprises:

In another aspect of the embodiment of the present disclosure, an electronic device is provided, comprising:

a housing 401;

an input apparatus 402 arranged in the housing 401 and configured to acquire an input operation;

a display 403 arranged on the housing 401; and

a processor 404 arranged in the housing 401 and configured to generate an instruction for invoking a task manager based on the input operation; make a response to the instruction for the task manager to invoke M application programs which are already in an operational state, wherein M is an integer greater than or equal to 1; control an application interface of each of the M application programs to be displayed in a window manner on the display 403, wherein when the application interface of said each application program is displayed in the window manner, said each application program is in an activated state, wherein when the M application programs are in an activated state, the M application programs can respond to interactive operations implemented by a user on displayed objects on the application interfaces of the M application programs.

Alternatively, before the input apparatus 402 acquires an input operation, only one of the M application programs can run in the foreground at the same time, and remaining application programs run in the background.

Alternatively, the processor 404 is configured to enable a multi-task management mode, wherein when the electronic device is in the multi-task management mode, the electronic device supports a first type of interactive operations implemented on displayed objects in the windows in the multi-task management mode.

Alternatively, the electronic device further comprises a sensor, wherein

the processor 404 is configured to acquire a first input operation via the sensor after controlling an application interface of each of the M application programs to be displayed in a window manner on the display 403; and

the processor 404 is further configured to determine whether the first input operation belongs to the first type of interactive operations.

Alternatively, the processor 404 is further configured to:

when the first input operation belongs to the first type of interactive operations, determine a first operation instruction according to first input information of the first input operation; submit the first operation instruction to a first application program corresponding to a first window which is determined based on the first input information; and control the first application program to make a response to the first operation instruction based on a displayed object in the first window.

Alternatively, the processor 404 is further configured to:

when the first input operation belongs to the first type of interactive operations, submit second input information of the first input operation to a first application program corresponding to a first window which is determined based on the second input information; control the first application program to generate a second operation instruction according to the second input information; and control the first application program to make a response to the second operation instruction based on a displayed object in the first window.

Specifically, the processor 404 may specifically be a general Central Processing Unit (CPU), an Application Specific Integrated Circuit (ASIC for short), or one or more integrated circuits for controlling execution of programs. The input apparatus 402 may acquire an operation implemented by a user on the electronic device, for example, an operation of implementing long press on a home key by a user. The sensor comprises a touch unit arranged thereon, and after the sensor is installed on the display 403 of the electronic device, the display 403 becomes a touch screen, and may acquire various gesture operations of the user, for example, single click, upward flick, long press or the like.

Further, the electronic device may further comprise one or more memories. The memory may comprise a Read Only Memory (ROM for short), a Random Access Memory (RAM for short) and a disk memory.

Various variations and specific examples of the above information processing method according to the embodiment in FIG. 1 are applicable to the electronic device according to the present embodiment. With the above detailed description of the information processing method, those skilled in the art can clearly understand the implementation of the electronic device according to the present embodiment, which thus will not be described in detail here for brevity of the description.

With one or more technical solutions according to the embodiments of the present disclosure, the following one or more technical effects can be achieved.

In the related art, when a user implements an operation in a task manager of an electronic device, the user can only implement operations such as deleting an application program as a whole, entering an application, and displaying application information. If there is a need to operate on a displayed object in an application interface of an application program, it needs to firstly click on the application program in the task manager to start and activate the application program, and then operate on the displayed object on an application interface of the activated application program, which results in low efficiency. The present embodiment solves the problem in the related art. Specifically, the task manager is improved to have more functions, and when the application programs in the task manager are in an activated state, in addition to achieving the functions in the related art, a response can further be made to interactive operations implemented by a user on displayed objects in the application interfaces of the application programs, and the interactive operations are implemented on an interface of the task manager all the time without exiting the task manager. The technical solutions of the present disclosure achieve more powerful functions of the task manager and better user experience.

Those skilled in the art should appreciate that the embodiments of the present disclosure can be provided as methods, systems, or computer program products. Therefore, forms such as hardware-only embodiments, software-only embodiments, or embodiments combining software and hardware can be used in the present disclosure. In addition, forms such as a computer program product which is implemented on one or more of computer usable storage media (comprising but not limited to a disk memory, a CD-ROM, an optical memory etc.) with computer usable program codes can be used in the present disclosure.

The present disclosure is described with reference to the flowcharts and/or block diagrams of the methods, devices (systems) and computer program products according to the embodiments of the present disclosure. It should be understood that each flow and/or block in the flowcharts and/or block diagrams as well as a combination of the flows and/or blocks in the flowcharts and/or block diagrams can be implemented by computer program instructions. These computer program instructions can be provided to a processor of a general-purpose computer, a dedicated-purpose computer, an embedded processor, or other programmable data processing devices to generate a machine. Thereby, the instructions executed by the processor of the computer or other programmable data processing devices generate means for implementing functions specified in one or more flows in the flowcharts and/or one or more blocks in the block diagrams.

These computer program instructions can also be stored in a computer readable memory capable of introducing a computer or other programmable data processing devices to operate in a particular mode. Thereby, the instructions stored in the computer readable memory generate an article of manufacture comprising instruction means for implementing functions specified in one or more flows in the flowcharts and/or one or more blocks in the block diagrams.

These computer program instructions can also be loaded onto a computer or other programmable data processing devices, so as to enable a series of operation steps to be performed on the computer or other programmable devices to generate a computer-implemented process. Thereby, the instructions executed on the computer or other programmable devices provide a step of implementing functions specified in one or more flows in the flowcharts and/or one or more blocks in the block diagrams.

Specifically, computer program instructions corresponding to the information processing method according to the embodiments of the present disclosure may be stored on a storage medium such as an optical disk, a hard disk, a USB device etc. When the computer program instructions in the storage medium corresponding to the information processing method are read or executed by an electronic device, the following steps are performed:

acquiring an input operation to generate an instruction for invoking a task manager;

responding to the instruction for the task manager to invoke M application programs which are already in an operational state, wherein M is an integer greater than or equal to 1;

controlling an application interface of each of the M application programs to be displayed in a window manner, wherein when the application interface of said each application program is displayed in the window manner, said each application program is in an activated state,

wherein when the M application programs are in an activated state, the M application programs can respond to interactive operations implemented by a user on displayed objects on the application interfaces of the M application programs.

Alternatively, before acquiring an input operation, only one of the M application programs can run in the foreground at the same time, and remaining application programs run in the background.

Alternatively, responding to the instruction for the task manager comprises:

enabling a multi-task management mode, wherein when the electronic device is in the multi-task management mode, the electronic device supports a first type of interactive operations implemented on displayed objects in the windows in the multi-task management mode.

Alternatively, after controlling an application interface of each of the M application programs to be displayed in a window manner, the method further comprises:

acquiring a first input operation via a sensor of the electronic device; and

determining whether the first input operation belongs to the first type of interactive operations.

Alternatively, after determining whether the first input operation belongs to the first type of interactive operations, the method further comprises:

when the first input operation belongs to the first type of interactive operations, determining a first operation instruction according to first input information of the first input operation;

submitting the first operation instruction to a first application program corresponding to a first window which is determined based on the first input information; and

responding, by the first application program, to the first operation instruction based on a displayed object in the first window.

Alternatively, after determining whether the first input operation belongs to the first type of interactive operations, the method further comprises:

when the first input operation belongs to the first type of interactive operations, submitting second input information of the first input operation to a first application program corresponding to a first window which is determined based on the second input information;

generating, by the first application program, a second operation instruction according to the second input information; and

responding, by the first application program, to the second operation instruction based on a displayed object in the first window.

Although preferable embodiments of the present disclosure have been described, additional changes and modifications can be made to these embodiments by those skilled in the art upon learning the basic creative concepts. Therefore, the appended claims are intended to be construed as comprising the preferable embodiments and all changes and modifications that fall into the scope of the present disclosure.

Obviously, various modifications and variants can be made to the present disclosure by those skilled in the art without departing from the spirit and scope of the present disclosure. Therefore, these modifications and variants are to be encompassed by the present disclosure if they fall within the scope of the present disclosure as defined by the claims and their equivalents.

I/We claim:

1. An information processing method, comprising:
acquiring an input operation to generate an instruction for invoking a task manager;
responding to the instruction for the task manager to invoke M application programs which are already in an operational state, wherein M is an integer greater than or equal to 1; and
controlling an application interface of each of the M application programs to be displayed in a window manner, wherein when the application interface of said each application program is displayed in the window manner, said each application program is in an activated state,
wherein when the M application programs are in an activated state, the M application programs can respond to interactive operations of a user on displayed objects on the application interfaces of the M application programs.

2. The method according to claim 1, wherein before the acquiring of an input operation, only one of the M application programs can run in the foreground at a time, and remaining application programs run in the background.

3. The method according to claim 2, wherein making the responding to the instruction for the task manager comprises:
enabling a multi-task management mode, wherein when the electronic device is in the multi-task management mode, the electronic device supports a first type of interactive operations on displayed objects in the windows in the multi-task management mode.

4. The method according to claim 3, wherein after the controlling of an application interface of each of the M application programs to be displayed in a window manner, the method further comprises:
acquiring a first input operation via a sensor of the electronic device; and
determining whether the first input operation belongs to the first type of interactive operations.

5. The method according to claim 4, wherein after the determining of whether the first input operation belongs to the first type of interactive operations, the method further comprises:
when the first input operation belongs to the first type of interactive operations, determining a first operation instruction according to first input information of the first input operation;
submitting the first operation instruction to a first application program corresponding to a first window which is determined based on the first input information; and
responding, by the first application program, to the first operation instruction based on a displayed object in the first window.

6. The method according to claim 4, wherein after the determining of whether the first input operation belongs to the first type of interactive operations, the method further comprises:
when the first input operation belongs to the first type of interactive operations, submitting second input information of the first input operation to a first application program corresponding to a first window which is determined based on the second input information;
generating, by the first application program, a second operation instruction according to the second input information; and
responding, by the first application program, to the second operation instruction based on a displayed object in the first window.

7. An electronic device, comprising:
a housing;
an input apparatus arranged in the housing and configured to acquire an input operation;
a display arranged on the housing; and
a processor arranged in the housing and configured to:
generate an instruction for invoking a task manager based on the input operation;
respond to the instruction for the task manager to invoke M application programs which are already in an operational state, wherein M is an integer greater than or equal to 1; and
control an application interface of each of the M application programs to be displayed in a window manner on the display, wherein when the application interface of said each application program is displayed in the window manner, said each application program is in an activated state,
wherein when the M application programs are in an activated state, the M application programs can respond to interactive operations of a user on displayed objects on the application interfaces of the M application programs.

8. The electronic device according to claim 7, wherein before the input apparatus acquires an input operation, only one of the M application programs can run in the foreground at a time, and remaining application programs run in the background.

9. The electronic device according to claim 8, wherein the processor is configured to enable a multi-task management mode, wherein when the electronic device is in the multi-task management mode, the electronic device supports a first type of interactive operations on displayed objects in the windows in the multi-task management mode.

10. The electronic device according to claim 9, further comprising a sensor, wherein
the processor is configured to acquire a first input operation via the sensor after the controlling of an application interface of each of the M application programs to be displayed in a window manner on the display; and
the processor is further configured to determine whether the first input operation belongs to the first type of interactive operations.

11. The electronic device according to claim 10, wherein the processor is further configured to:
when the first input operation belongs to the first type of interactive operations, determine a first operation instruction according to first input information of the first input operation;
submit the first operation instruction to a first application program corresponding to a first window which is determined based on the first input information; and
control the first application program to respond to the first operation instruction based on a displayed object in the first window.

12. The electronic device according to claim 10, wherein the processor is further configured to:
when the first input operation belongs to the first type of interactive operations, submit second input information of the first input operation to a first application program corresponding to a first window which is determined based on the second input information;
control the first application program to generate a second operation instruction according to the second input information; and
control the first application program to respond to the second operation instruction based on a displayed object in the first window.
